(19) United States
(12) Patent Application Publication
(10) Pub. No.: US 2026/0105719 A1
(43) Pub. Date: Apr. 16, 2026

(54) TEMPORAL ASSISTANT MODULE

(71) Applicant: National Taipei University of Technology, Taipei (TW)

(72) Inventors: XIU-ZHI CHEN, Taipei (TW); YEN-LIN CHEN, Taipei (TW); YI-KAI CHIU, Taipei (TW); CHIH-SHENG HUANG, Taipei (TW)

(21) Appl. No.: 18/916,662

(22) Filed: Oct. 15, 2024

(51) Int. Cl. G06V 10/62; G06V 10/74; G06V 10/82

(52) U.S. Cl. CPC G06V 10/62; G06V 10/761; G06V 10/82

(57) ABSTRACT

The present invention is a temporal assistant module for monocular 3D object detection, where hidden state information (Hₜ) at a current time point and output state information (Yₜ) at the current time point of a recurrent neural networks module, a long short-term memory module (LSTM module), and a gated recurrent unit module (GRU module) are adjusted separately by using the temporal assistant module, thereby enhancing average precision (AP) of auxiliary effect on object being shielded, object moving out of a detection image, or small object detection.

### FIELD OF TECHNOLOGY

The present invention relates to a module for object detection, and in particular to a temporary assistant module for monocular 3D object detection.

### BACKGROUND

In the prior art, FIG. 1 shows an operation flow of a recurrent neural network. First, a hidden state is initialized to ensure that initial values of all sets of sequence data are the same. When sequence data is started to be input, the stored hidden state is integrated with the sequence, and a hidden layer 11 is used for calculation, so that a new hidden state and a new sequence are output. This process is repeated, so that new feature information is learned in a hidden layer of each round, and corresponding result information is output. Output state information at a time point T0 is Y_{T0},

input state information at the time point T0 is X_{T0}, hidden state information at the time point T0 is H_{T0}, output state information at a time point T1 is Y_{T1}, input state information at the time point T1 is X_{T1}, hidden state information at the time point T1 is H_{T1}, output state information at a time point T2 is Y_{T2}, input state information at the time point T2 is X_{T2}, and hidden state information at the time point T2 is H_{T2}.

In the prior art, as shown in FIG. 2, a hidden layer of a recurrent neural networks module 21 plays an important role in an overall architecture, which enables a model to integrate input information with a hidden state of a previous layer. FIG. 2 shows a basic unit of the hidden layer, which integrates the hidden state h with input information X at a current time point, and generates output information Y and a new hidden state h through an activation function.

In the prior art, as shown in FIG. 3, a long short-term memory (LSTM) 31 is a modified version of the recurrent neural networks, which use sequential data for input, just like traditional recurrent neural networks. In design, to improve a problem of gradient explosion and disappearance when the sequence data is long, a cell state and three gates constructed by Sigmoid functions are added to the LSTM to improve the original hidden state, namely a forget gate, an input gate, and an output gate, so that the LSTM can better learn feature information of a long time sequence, as shown in FIG. 3.

In the long short-term memory (LSTM) in the prior art, when a time point t is calculated, first, a hidden state at a previous time point is integrated with current feature information, and then integrated information is sent to three same gates for calculation. For the forget gate, as shown in equation (2.1), which generates a set of values F between 0 and 1 by using the hidden state and a current feature result, where F represents whether or not to forget information in a cell state, so that information used is necessary for a current state, and data that has been retained for too long is removed. The input gate is shown in equation (2.2) and equation (2.3), which respectively represent a proportion I of a cell state to be updated in the data and information S to be updated to the cell state. The output gate is shown in equation (2.4), which mainly determines data with the cell state to be output, and a proportion 0 to be output is calculated through the Sigmoid function. Finally, output of each gate and a cell state and hidden state at a previous time point are calculated, and then information output by the LSTM can be obtained, as shown in equation (2.5) and equation (2.6).

$$F = σ 0 W 0 \cdot [ h , X ] + b 00 \qquad ( 2.1 )$$

$$I = σ ( W 0 \cdot [ h , X ] + b 0 ) \qquad ( 2.2 )$$

$$S = ( W 0 \cdot [ h , X ] + b 0 ) \qquad ( 2.3 )$$

$$O = σ ( W 0 \cdot [ h , X ] + b 0 ) \qquad ( 2.4 )$$

$$C = F * C + I * S \qquad ( 2.5 )$$

$$h = O * tanh ( C ) \qquad ( 2.6 )$$

In the prior art, as shown in FIG. 4, a gated recurrent unit (GRU) 41 is a fairly representative and modified version of the LSTM. In the GRU, the input gate and the forget gate in the LSTM are adjusted and named as an update gate and a reset gate respectively, the cell state is integrated with the hidden state, and the output gate is omitted, so that an architecture thereof is much simpler than an architecture of a traditional LSTM, as shown in FIG. 4.

In the prior art, as shown in FIG. 4, in terms of data flow, a previous hidden state is first integrated with current input data, integrated information is transferred to the update gate, a set of values Z between 0 and 1 is obtained through the Sigmoid function, and a proportion of data to be transferred is determined by this value, as shown in equation (2.7). For the reset gate, a main goal is to determine how much previous information needs to be forgotten, and to obtain a set of values R between 0 and 1 through the Sigmoid function, which is the same as the update gate, as shown in equation (2.8). For processing current data, for example, in equation (2.9), information in a previous hidden state h and R calculated in the reset gate are calculated, and information to be forgotten is removed, so that information O to be continuously transferred is obtained. Finally, either the hidden state h or current data O and an update ratio Z are calculated, to obtain a new hidden state h, as in equation (2.10).

$$Z = σ ( W 0 \cdot [ h , X ] ) \qquad ( 2.7 )$$

$$R = σ ( W 0 \cdot [ h , X ] ) \qquad ( 2.8 )$$

$$O = tanh ( W \cdot [ R * h , X ] ) \qquad ( 2.9 )$$

$$h = ( 1 - Z ) * h + Z * O \qquad ( 2.1 0 )$$

### SUMMARY

The present invention is a temporal assistant module for monocular 3D object detection, where the temporal assistant module is connected to at least one of a recurrent neural networks module, a long short-term memory module (LSTM module), and a gated recurrent unit module (GRU module) separately, a video frame of a spatio-temporal feature map is processed by the temporal assistant module, and the temporal assistant module includes: a first convolutional 2D layer, where hidden state information (Hₜ₋₁) at a previous time point is input to the first convolutional 2D layer; a second convolutional 2D layer, where input state information (Xₜ) at a current time point is input to the second convolutional 2D layer; a first connection layer, where the hidden state information (Hₜ₋₁) is output from the first convolutional 2D layer to the first connection layer, and the input state information (Xₜ) is output from the second convolutional 2D layer to the first connection layer; and a third convolutional 2D layer, where the hidden state information (Hₜ₋₁) and the input state information (Xₜ) are output from the first connection layer to the third convolutional 2D layer, and hidden state information (Hₜ) at the current time point and output state information (Yₜ) at the current time point of the recurrent neural networks module, the long short-term memory module (LSTM module), and the gated recurrent unit module (GRU module) are adjusted separately by using the temporal assistant module, thereby enhancing average precision (AP) of auxiliary effect on object being shielded, object moving out of a detection image, or small object detection.

The present invention is a temporal assistant module, where the following layers are included: a backbone layer, where an input end of the backbone layer is connected to an input data feature, to extract the input data feature; and an input end of the temporal assistant module is connected to an output end of the backbone layer; a neck layer, where an input end of the neck layer is connected to an output end of the temporal assistant module, to fuse the data feature; and a detection head layer, where an output end of the neck layer is connected to an input end of the detection head layer.

The present invention is a temporal assistant module, where the following layers are included: a backbone layer, where an input end of the backbone layer is connected to an input data feature, to extract the input data feature; a neck layer, where an input end of the neck layer is connected to an output end of the backbone layer, to fuse the data feature; and the temporal assistant module is placed in the neck layer to integrate data features at different scales; and a detection head layer, where an output end of the neck layer is connected to an input end of the detection head layer.

The present invention is a temporal assistant module, where the following layers are included: a backbone layer, where an input end of the backbone layer is connected to an input data feature, to extract the input data feature; a neck layer, where an input end of the neck layer is connected to the backbone layer, to fuse the data feature; and an input end of the temporal assistant module is connected to an output end of the backbone layer; and a detection head layer, where an output end of the temporal assistant module is connected to an input end of the detection head layer.

The present invention is a temporal assistant module. In the recurrent neural networks module, the hidden state information (Hₜ₋₁) and the input state information (Xₜ) are separately output from the third convolutional 2D layer to a first activation function layer, and the first activation function layer outputs the hidden state information (Hₜ) at the current time point and the output state information (Yₜ) at the current time point separately.

The present invention is a temporal assistant module. The long short-term memory module (LSTM module) includes: the third convolutional 2D layer outputs information and is connected to a forget gate, an input gate, a second activation function layer, and an output gate separately, where the forget gate, the input gate, and the output gate are Sigmoid functions; output information of the forget gate is multiplied by Ct=1 information to obtain first information, output information of the input gate is multiplied by output information of the second activation function layer to obtain second information, and after the first information is added to the second information, added information is output to a third activation function layer and a cell state (Cₜ) at a current time point; and after output information of the second activation function layer is multiplied by information of the output gate, the hidden state information (Hₜ) at the current time point and the output state information (Yₜ) at the current time point are output respectively.

The present invention is a temporal assistant module, where the gated recurrent unit module (GRU module) includes: the third convolutional 2D layer outputs information and is connected to a reset gate and an update gate separately, where the reset gate and the update gate are Sigmoid functions; after output information of the reset gate is multiplied by output information of the first convolutional 2D layer, multiplied information is output to a second connection layer 57, output information of the second connection layer 57 is output to a fourth convolutional 2D layer, and output information of the fourth convolutional 2D layer is output to a fourth activation function layer; and after output information of the first convolutional 2D layer is multiplied by delayed output information of the update gate, third information is output, after output information of the update gate is multiplied by output information of the fourth activation function layer, fourth information is output, and after the third information is added to the fourth information, the hidden state information (Hₜ) at the current time point and the output state information (Yₜ) at the current time point are respectively output.

The present invention is a temporal assistant module that processes a video frame of a spatio-temporal feature map for object detection and includes: at least one anchor base module, where the at least one anchor base module cuts a feature map into a plurality of grids of different proportions, places at least one set anchor base in each grid, captures anchor bases with a highest overlap rate, and performs object detection by adjusting an offset.

The present invention is a temporal assistant module that processes a video frame of a spatio-temporal feature map for object detection and includes: at least one anchor free module, where the anchor free module performs object detection by finding coordinates of a center point of an object on a feature map and predicting distances between the center point and upper, left, and, right boundaries.

The present invention is a temporal assistant module, where hidden state information (Hₜ) at the current time point and output state information (Yₜ) at the current time point of the recurrent neural networks module, the long short-term memory module (LSTM module), and the gated recurrent unit module (GRU module) are adjusted separately, thereby enhancing average precision (AP) of auxiliary effect on object being shielded, object moving out of a detection image, or small object detection.

### BRIEF DESCRIPTION OF THE DRAWINGS

The application file contains at least one drawing executed in color. Copies of this patent or patent application publication with color drawing(s) will be provided by the Office upon request and payment of the necessary fee.

FIG. 1 is a schematic flow chart of recurrent neural networks in the prior art.

FIG. 2 is a schematic diagram of a recurrent neural networks cell in the prior art.

FIG. 3 is a schematic diagram of a long short-term memory cell (LSTM cell) in the prior art.

FIG. 4 is a schematic diagram of a gated recurrent unit cell (GRU cell) in the prior art.

FIG. 5 is a schematic diagram of recurrent neural networks according to the present invention.

FIG. 6 is a schematic diagram of a recurrent neural networks cell according to the present invention.

FIG. 7 is a schematic diagram of a long short-term memory cell (LSTM cell) according to the present invention.

FIG. 8 is a schematic diagram of a backbone layer and a temporal module added behind the backbone layer according to the present invention.

FIG. 9 is a schematic diagram of a neck layer with a temporal module added according to the present invention.

FIG. 10 is a schematic diagram of a detection head layer and a temporal module added before the detection head layer according to the present invention.

FIG. 11 is a schematic diagram of anchor based object detection according to the present invention.

FIG. 12 is a schematic diagram of anchor free object detection according to the present invention.

FIG. 13 is a schematic diagram of a problem that a forget gate is not added to a temporal module according to the present invention.

FIG. 14 is a schematic diagram of auxiliary effect on object being shielded after a temporal module is added to VisualDet3D according to the present invention.

FIG. 15 is a schematic diagram of auxiliary effect on object moving out of an image after a temporal module is added to VisualDet3D according to the present invention.

FIG. 16 is a schematic diagram of auxiliary effect on small object detection after a temporal module is added to VisualDet3D according to the present invention.

FIG. 17 is a schematic diagram of detection effect in a normal circumstance after a temporal module is added to VisualDet3D according to the present invention.

FIG. 18 is a schematic diagram of auxiliary effect on object being shielded after a temporal module is added to Monodle according to the present invention.

FIG. 19 is a schematic diagram of auxiliary effect on object moving out of an image after a temporal module is added to Monodle according to the present invention.

FIG. 20 is a schematic diagram of auxiliary effect on small object detection after a temporal module is added to Monodle according to the present invention.

FIG. 21 is a schematic diagram of detection effect in a normal circumstance after a temporal module is added to Monodle according to the present invention.

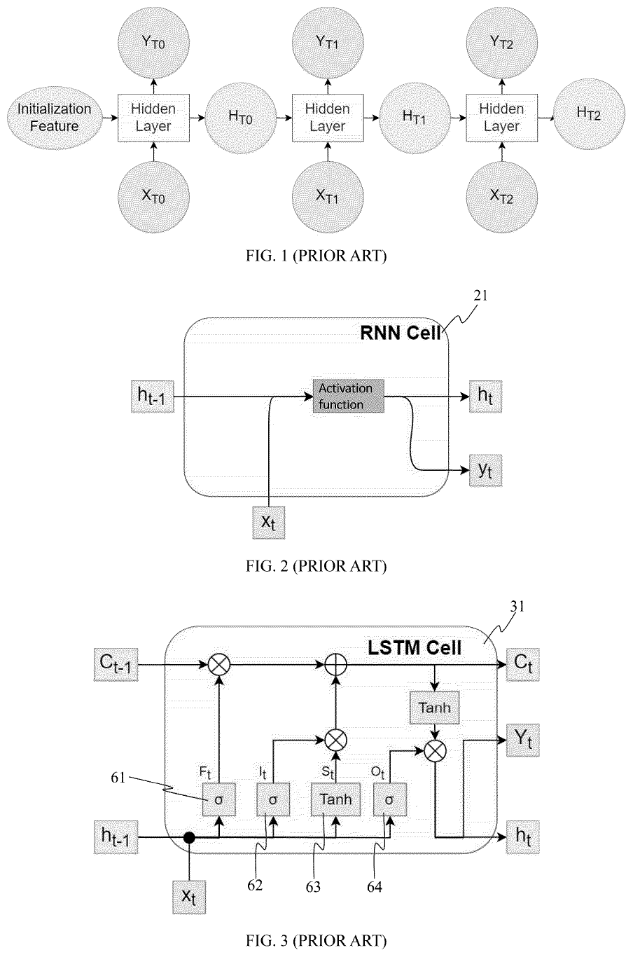

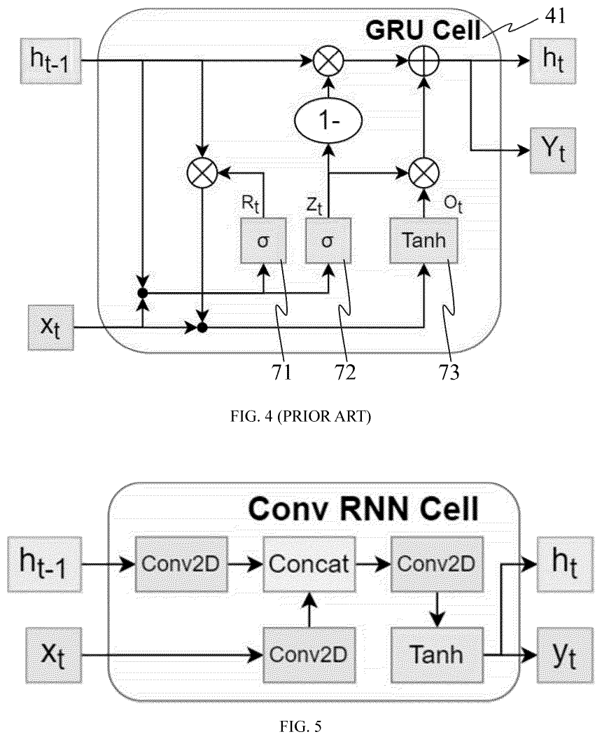

### DESCRIPTION OF THE EMBODIMENTS

As shown in FIG. 5 to FIG. 7, the present invention is a temporal assistant module 10 for monocular 3D object detection. The temporal assistant module 10 is connected to at least one of a recurrent neural networks module 501, a long short-term memory module 601 (LSTM module), and a gated recurrent unit module 701 (GRU module). A video frame of a spatio-temporal feature map is processed by the temporal assistant module 10. The temporal assistant module 10 includes: a first convolutional 2D layer, where a hidden state information (Hₜ₋₁) at a previous time point is input to the first convolutional 2D layer; a second convolutional 2D layer, where input state information (Xₜ) at a current time point is input to the second convolutional 2D layer; a first connection layer, where the hidden state information (Hₜ₋₁) is output from the first convolutional 2D layer to the first connection layer, and the input state information (Xₜ) is output from the second convolutional 2D layer to the first connection layer; and a third convolutional 2D layer 56, where the hidden state information (Hₜ₋₁) and the input state information (X₁) are output from the first connection layer to the third convolutional 2D layer 56. Hidden state information (Hₜ) at the current time point and output state information (Yₜ) at the current time point of the recurrent neural networks module 501 (RNN module 501), the long short-term memory module 601 (LSTM module 601), and the gated recurrent unit module 701 (GRU module 701) are adjusted separately by using the temporal assistant module 10, thereby enhancing average precision (AP) of auxiliary effect on object being shielded, object moving out of a detection image, or small object detection.

As shown in FIG. 5, the present invention is a temporal assistant module 10. In the recurrent neural networks module 501, the hidden state information (Hₜ₋₁) and the input state information (Xₜ) are output from the third convolutional 2D layer 56 to a first activation function layer, and the first activation function layer outputs the hidden state information (Hₜ) at the current time point and the output state information (Yₜ) at the current time point separately.

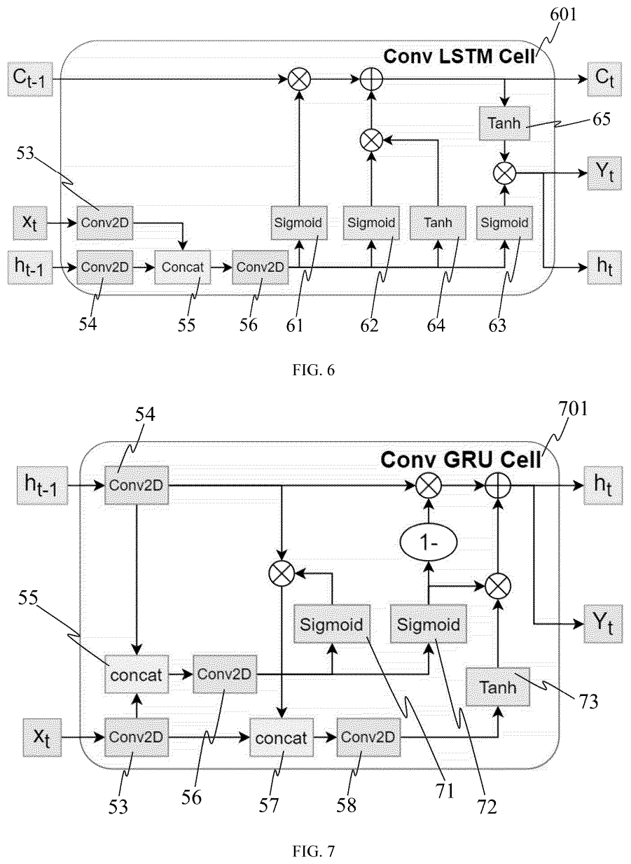

As shown in FIG. 6, the present invention is a temporal assistant module 10. The long short-term memory module (LSTM module) 601 includes: the third convolutional 2D layer 56 outputs information and is connected to a forget gate 61, an input gate 62, a second activation function layer, and an output gate 63 separately, where the forget gate 61, the input gate 62, and the output gate 63 are Sigmoid functions; output information of the forget gate 61 is multiplied by Ct=1 information to obtain first information, output information of the input gate 62 is multiplied by output information of the second activation function layer to obtain second information, and after the first information is added to the second information, added information is output to a third activation function layer 56 and a cell state (Cₜ) at a current time point; and after output information of the second activation function layer is multiplied by information of the output gate 63, the hidden state information (Hₜ) at the current time point and the output state information (Yₜ) at the current time point are output respectively.

As shown in FIG. 7, the present invention is a temporal assistant module 10, where the gated recurrent unit module 701 (GRU module) includes: the third convolutional 2D layer 56 outputs information and is connected to a reset gate 71 and an update gate 72 separately, where the reset gate 71 and the update gate 72 are Sigmoid functions; after output information of the reset gate 71 is multiplied by output information of the first convolutional 2D layer, multiplied information is output to a second connection layer 57, output information of the second connection layer 57 is output to a fourth convolutional 2D layer 58, and output information of the fourth convolutional 2D layer 58 is output to a fourth activation function layer 58; and after output information of the first convolutional 2D layer is multiplied by delayed output information of the update gate 72, third information is output, after output information of the update gate 72 is multiplied by output information of the fourth activation function layer 58, fourth information is output, and after the third information is added to the fourth information, the hidden state information (Hₜ) at the current time point and the output state information (Yₜ) at the current time point are respectively output.

As shown in Table 1, the present invention is a temporal assistant module 10. When the improved temporal assistant module 10 is tested, a VisualDet3D model is used for initial testing, a model architecture without the temporal module is defined as a baseline, improved RNN, LSTM, and GRU modules are respectively added at a same position, and average precision (AP) is compared through 2D, bird's eye view, and 3D. In other words, values of 2D AP, BEV AP, and 3D AP are used for initial comparison in model effectiveness. Initial data is shown in the following Table 1. Rates of object being shielded are divided with reference to KITTI into three levels: E (easy), M (moderate), and H (hard), where H (hard) indicates a highest shielding rate, red in numerical value indicates highest precision in a field, and bold indicates data with a higher precision than a baseline.

As shown in Table 1, the present invention is a temporal assistant module 10.

| | 2D | | | 3D | | | 3D | | |
|---|---|---|---|---|---|---|---|---|---|
| KITTI | AP70↑ | | | AP70↑ | | | AP 50↑ | | |
| Car | E | M | H | E | M | H | E | M | H |
| Baseline | 97.30 | 84.54 | 64.65 | 19.43 | 13.60 | 10.82 | 55.49 | 39.03 | 30.86 |
| RNN | 97.28 | 84.55 | 64.66 | 21.77 | 15.41 | 11.85 | 56.21 | 39.59 | 31.36 |
| LSTM | 97.22 | 84.49 | 67.00 | 21.24 | 15.78 | 12.07 | 59.13 | 41.71 | 32.02 |
| GRU | 97.27 | 86.92 | 67.06 | 20.89 | 14.66 | 11.74 | 57.32 | 41.44 | 31.82 |

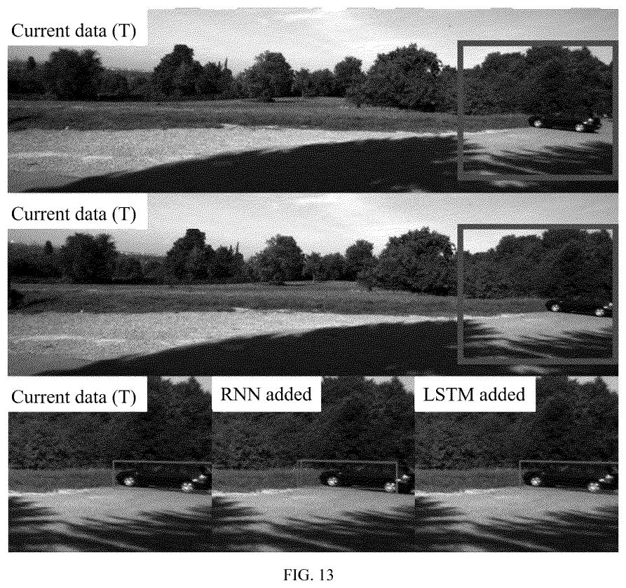

Based on the data in Table 1, it can be found that no matter which temporal module RNN, LSTM, or GRU is added, the precision in BEV and 3D has been increased. Although the precision is not better than the baseline in the 2D, the precision is the same in the LSTM and GRU. Compared with the LSTM, the RNN lacks the forget gate 61, and there is no difference or trade-off in a reference ratio of temporal data. Therefore, object marker box offset occurs, as shown in FIG. 13. In this preliminary experiment, it is verified that the temporal assistant module 10 of the present invention is helpful for the effect of 3D object detection, and an average increase of the effect of the LSTM is the most obvious.

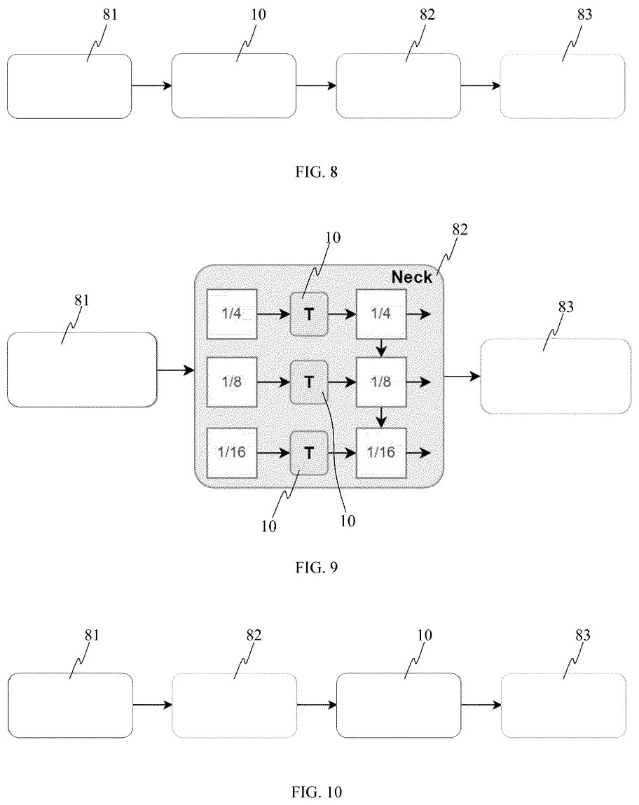

As shown in FIG. 8, the present invention is a temporal assistant module 10. In an architecture of FIG. 8, an image is first input into a backbone layer 81, feature extraction is performed through the backbone layer 81, and an obtained feature map includes only feature information of the image. In this case, the feature information includes only feature data in the most original image, but also includes a feature with the most information. Therefore, the temporal assistant module of the present invention is placed following the backbone layer 81, to maximize integration of feature data at different time points, and an integrated result is sent into a neck layer 82 for feature processing.

As shown in FIG. 8, the present invention is a temporal assistant module 10. The following layers are included in the figure: a backbone layer 81, where an input end of the backbone layer 81 is connected to an input data feature, to extract the input data feature; and an input end of the temporal assistant module 10 is connected to an output end of the backbone layer 81; a neck layer 82, where an input end of the neck layer 82 is connected to an output end of the temporal assistant module 10, to fuse the data feature; and a detection head layer 83, where an output end of the neck layer 82 is connected to an input end of the detection head layer 83.

As shown in FIG. 9, the present invention is a temporal assistant module 10. In addition, features of a backbone layer 81 are continuously transferred to a neck layer 82, the features at different scales are mainly integrated in the neck layer 82, the features of different sizes generated by the backbone layer 81 are extracted and calculated separately for integration, and a feature map with multi-scale information is output. An operation process for the neck layer 82 includes feature maps at all scales. Because sizes and feature information at all scales are different, the temporal assistant module 10 is placed in the neck layer 82. As shown in FIG. 9, a feature at an original scale can be retained by integrating feature maps at different scales for temporal integration. After obtained from the neck layer 82, the feature map is sent to a detection head layer 83 for model prediction, and the feature map obtained from the neck layer 82 has multi-scale feature information, to mainly enable the detection head layer 83 to have a better effect when calculating a large object and a small object.

As shown in FIG. 9, the present invention is a temporal assistant module 10. The following layers are included in the figure: a backbone layer 81, where an input end of the backbone layer 81 is connected to an input data feature, to extract the input data feature; a neck layer 82, where an input end of the neck layer 82 is connected to an output end of the backbone layer 81, to fuse the data feature, where the temporal assistant module 10 is placed in the neck layer 82 to integrate data features at different scales; and a detection head layer 83, where an output end of the neck layer 82 is connected to an input end of the detection head layer 83.

As shown in FIG. 10, the present invention is a temporal assistant module 10. The temporal assistant module 10 is placed before a detection head layer 83. As shown in FIG. 10, integrated multi-scale features are integrated by using the temporal assistant module 10, so that feature information input to the detection head layer 83 can contain not only object features at all scales, but also multi-scale object features at adjacent time points.

As shown in FIG. 10, the present invention is a temporal assistant module 10. The following layers are included in the figure: a backbone layer 81, where an input end of the backbone layer 81 is connected to an input data feature, to extract the input data feature; a neck layer 82, where an input end of the neck layer 82 is connected to the backbone layer 81, to fuse the data feature; and an input end of the temporal assistant module 10 is connected to an output end of the neck layer 82; and a detection head layer 83, where an output end of the temporal assistant module 10 is connected to an input end of the detection head layer.

As shown in Table 2, the present invention is a temporal assistant module 10. Testing is performed by placing the temporal assistant module 10 at different positions.

| | 2D | | | 3D | | | 3D | | |
|---|---|---|---|---|---|---|---|---|---|
| KITTI | AP70↑ | | | AP70↑ | | | AP 50↑ | | |
| Car | E | M | H | E | M | H | E | M | H |
| Baseline | 97.30 | 84.54 | 64.65 | 19.43 | 13.60 | 10.82 | 55.49 | 39.03 | 30.86 |
| After the | 87.39 | 72.21 | 54.78 | 17.09 | 11.25 | 8.58 | 51.78 | 35.05 | 27.01 |
| backbone | | | | | | | | | |
| In the neck | 94.50 | 76.99 | 59.58 | 18.58 | 12.56 | 9.81 | 52.75 | 36.42 | 28.53 |
| Before the | 97.33 | 82.19 | 64.70 | 21.24 | 15.78 | 12.07 | 59.13 | 41.71 | 32.02 |
| head | | | | | | | | | |

As shown in Table 2, the present invention is a temporal assistant module 10. In terms of an effect test at different placement positions, the VisualDet3D model architecture is also used for testing in the present invention. Based on results of a feasibility experiment of the module, the LSTM is selected as a module for use. The module is placed behind the backbone layer 81, in the neck layer 82, and the detection head layer 83 separately for testing, and 2D AP and 3D AP are used as evaluation indicators. Test results are shown in Table 2. Similarly, shielding rates are grouped with reference to KITTI. Based on the above experiment, although the temporal module can be added to different positions for assistance, only when the temporal module is added before the detection head layer 83, can auxiliary effect be achieved for the output result. The effect is not improved when the temporal module is added to the backbone layer 81 or the neck layer 82, but the output effect is reduced. Therefore, adding the temporal module before the detection head layer 83 is currently the best in testing.

As shown in FIG. 11, the present invention is a temporal assistant module 10, where Anchor Based is a method for object detection using an anchor. In the method, a feature map is cut into a plurality of grids with different proportions, and set anchors are placed in all grids, so that anchors with a highest overlap rate can be found, and object detection is performed by adjusting an offset. For the Anchor Based method, the design of the anchor is quite important. If the size of the designed anchor is extremely different from the size of an actual object, the burden on a model for training is increased, leading to poor convergence effect. Common anchor box design methods include an empirical rule and data clustering. In the empirical rule, the size and parameters of the anchor are set based on designer's past experience. In the data clustering, based on results in statistically labeled data, corresponding anchor parameters are set through clustering.

As shown in Table 3, the present invention is a temporal assistant module 10. The temporal assistant module for verification can be used in the anchor-based model. A model architecture proposed in VisualDet3D is used for testing. and the temporal assistant module is added before a detection head of the model, so that the model can integrate image features in observed data, and a feature map after integration by the assistant module is transferred to the detection head for detection task.

As shown in Table 3, the present invention is a temporal assistant module 10 that processes a video frame of a spatio-temporal feature map for object detection, including: at least one anchor base module. The at least one anchor base module cuts a feature map into a plurality of grids of different proportions, places at least one set anchor base in each grid, captures anchor bases with a highest overlap rate, and performs object detection by adjusting an offset.

As shown in Table 3, the present invention is a temporal assistant module 10. The temporal assistant module is used in the VisualDet3Det.

| | 2D AP70↑ | | | BEV AP70↑ | | | 3D AP70↑ | | | BEV AP50↑ | | | 3D P50↑ | | |
|---|---|---|---|---|---|---|---|---|---|---|---|---|---|---|---|
| Car | E | M | H | E | M | H | E | M | H | E | M | H | E | M | H |
| Baseline | 96.75 | 84.07 | 64.66 | 26.66 | 19.35 | 15.06 | 18.96 | 13.73 | 10.72 | 61.64 | 43.95 | 34.17 | 55.85 | 40.14 | 25.40 |
| LSTM | 96.75 | 84.07 | 66.06 | 28.48 | 20.55 | 16.12 | 20.90 | 15.27 | 11.77 | 63.87 | 45.44 | 35.13 | 59.12 | 41.86 | 32.06 |
| Diff. | 0.00 | 0.00 | +1.40 | +1.82 | +1.21 | +1.06 | +1.94 | +1.54 | +1.05 | +2.23 | +1.50 | +0.97 | +3.27 | +1.72 | +6.66 |
| | 2D AP50↑ | | | BEV AP50↑ | | | 3D AP50↑ | | | BEV AP25↑ | | | 3D P25↑ | | |
| Car | E | M | H | E | M | H | E | M | H | E | M | H | E | M | H |
| Baseline | 55.98 | 46.22 | 39.29 | 8.39 | 6.71 | 5.09 | 7.44 | 5.83 | 4.64 | 27.13 | 22.07 | 18.48 | 26.34 | 21.35 | 17.56 |
| LSTM | 58.43 | 47.05 | 40.14 | 9.46 | 7.52 | 5.69 | 8.31 | 6.49 | 5.14 | 28.87 | 23.66 | 19.64 | 28.20 | 22.81 | 19.10 |
| Diff. | +2.45 | +0.83 | +0.84 | +1.07 | +0.81 | +0.60 | 0.87 | +0.66 | +0.50 | +1.74 | +1.59 | 1.16 | +1.86 | +1.47 | +1.54 |
| | 2D AP50↑ | | | BEV AP50↑ | | | 3D AP50↑ | | | BEV AP25↑ | | | 3D P25↑ | | |
| Cyclist | E | M | H | E | M | H | E | M | H | E | M | H | E | M | H |
| Baseline | 53.09 | 32.25 | 30.43 | 3.59 | 1.98 | 2.00 | 3.04 | 1.72 | 1.65 | 14.54 | 8.22 | 7.75 | 13.47 | 7.50 | 7.47 |
| LSTM | 54.61 | 3.81 | 31.67 | 4.46 | 2.77 | 2.00 | 3.95 | 2.32 | 2.36 | 16.70 | 9.57 | 9.50 | 15.68 | 9.03 | 8.76 |
| Diff. | +1.52 | +1.56 | +1.24 | +0.87 | +0.79 | +0.70 | +0.91 | +0.60 | +0.71 | +2.16 | +1.35 | +1.75 | +2.21 | +1.53 | +1.29 |
| | 2D↑ | | | BEV Hard↑ | | | 3D Hard↑ | | | BEV Easy↑ | | | 3D Easy↑ | | |
| mAP | E | M | H | E | M | H | E | M | H | E | M | H | E | M | H |
| Baseline | 96.75 | 84.07 | 64.66 | 12.88 | 9.35 | 7.38 | 9.81 | 7.09 | 5.67 | 34.44 | 24.75 | 20.13 | 31.88 | 23.00 | 16.81 |
| LSTM | 69.93 | 54.98 | 45.96 | 14.13 | 10.28 | 8.17 | 11.05 | 8.03 | 6.42 | 36.48 | 26.23 | 21.42 | 34.33 | 24.57 | 19.97 |
| Diff. | +1.33 | +0.80 | +1.16 | +1.25 | +0.94 | +0.79 | +1.24 | +0.93 | +0.75 | +2.04 | +1.48 | +1.29 | +2.45 | +1.57 | +3.16 |

As shown in Table 3, the present invention is a temporal assistant module 10. Through experimental data, it can be verified that average precision obtained when the temporal assistant module is added to the Anchor Based model is increased by approximately 1.4 times, although the auxiliary effect obtained when the temporal assistant module is added varies in individual categories. The effect of the assistant module on the original model is verified using the data, and the effect on an object shape being shielded, a part of the object shape moving out of an image, small object detection, and the like that are expected to be improved is verified using visualization results.

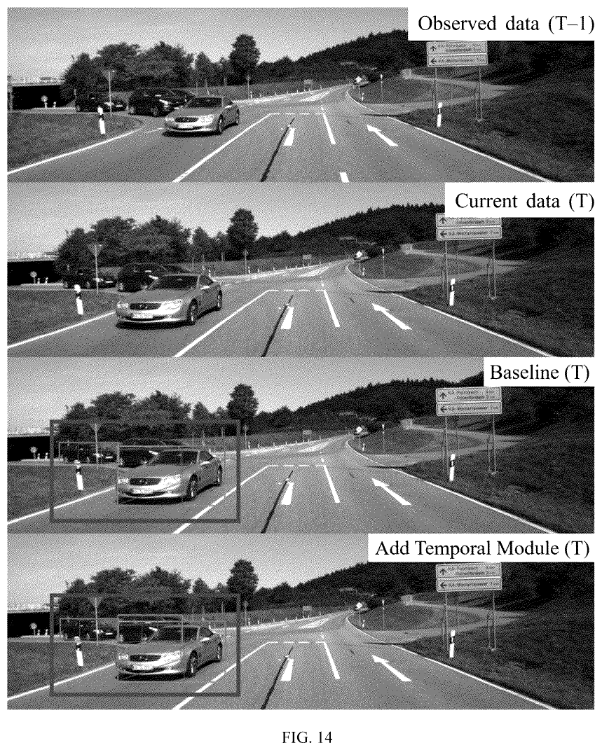

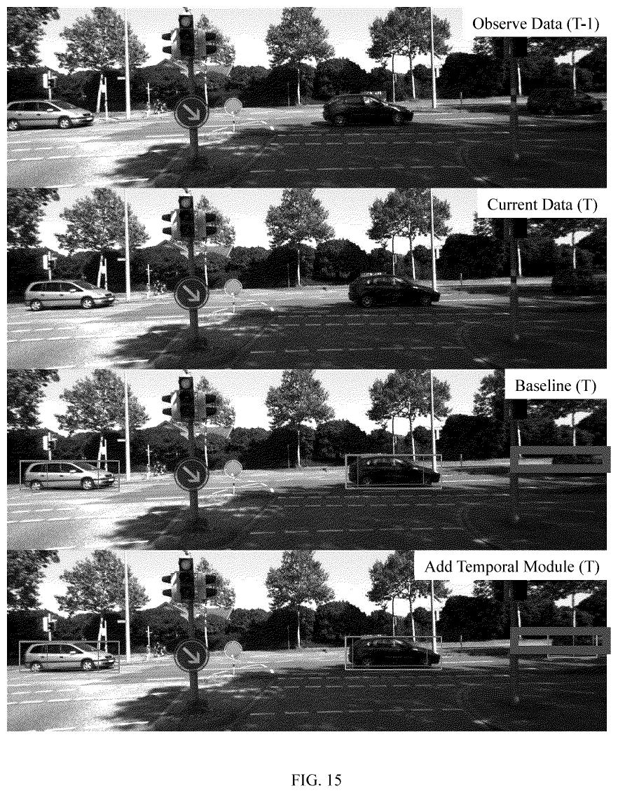

As shown in FIG. 14, the present invention is a temporal assistant module 10. Although a vehicle in the middle of an image is slightly shielded by a front car in observed data (T−1), it can still be seen that there is a car behind the front car. In current data (T), vehicle movement causes the vehicle to be shielded at a larger area, so that a baseline model cannot detect the vehicle. However, after the temporal assistant module 10 of the present invention is added, it can be learned that the shielded vehicle can still be detected.

As shown in FIG. 15, the present invention is a temporal assistant module 10. There is a car on the right side of observed data (T−1), but when time advances to current data (T), because the vehicle moves out of the image, and if a baseline model that considers only the current data, it is found that the car is not detected. However, when the temporal assistant module 10 of the present invention is used with reference to the observed data, the vehicle is detected due to temporal integration.

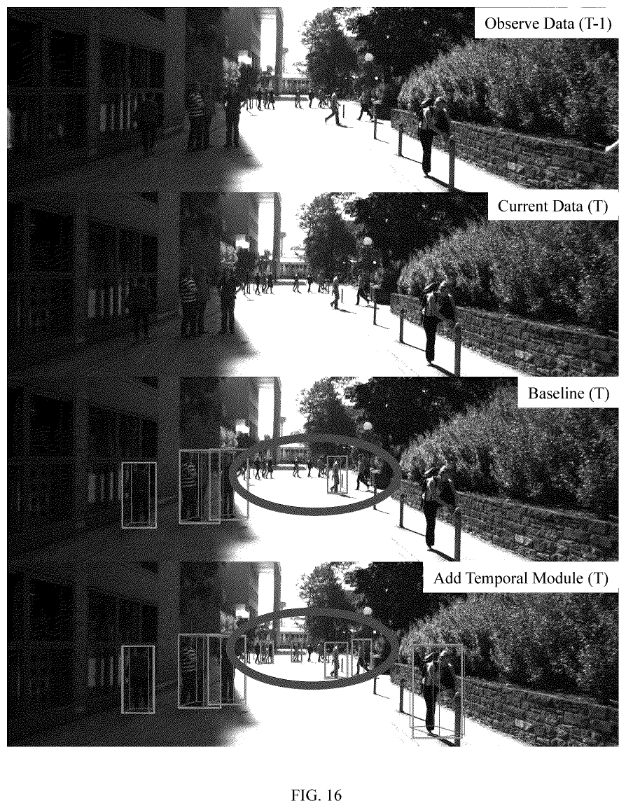

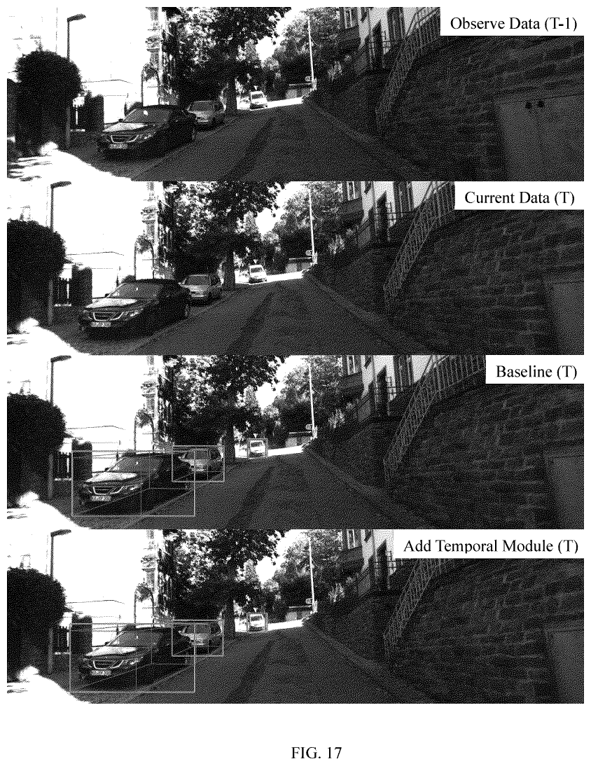

As shown in FIG. 16, the present invention is a temporal assistant module 10. In this embodiment, there is no shielding or moving out of an image between observed data (T−1) and current data (T), but there are a plurality of small objects in the image. In a Baseline model that uses only the current data, detection effect is poor because there are fewer features of the small objects. In a model with the temporal assistant module added, the detection of small objects is improved by integrating feature information of the observed data.

As shown in FIG. 17, the present invention is a temporal assistant module 10. Finally, in a case where no shielding, moving out of an image, or a small object occurs, as shown in FIG. 17, although the above special cases do not occur in a scene, three objects in the image appear at a current time point or at a past time point. After the temporal assistant module is added, determining is not affected, and the detection effect is the same as detection effect of a model without the temporal assistant module, demonstrating that adding the temporal assistant module 10 of the present invention does not reduce the original detection effect.

As shown in Table 3, the present invention is a temporal assistant module 10. A comparison result of the temporal assistant module 10 of the present invention with the VisualDet3D model is shown in Table 4. Through experimental data, it can be verified that average precision obtained when the temporal assistant module 10 is added to the Anchor Based is increased by approximately 1.4 times, although the auxiliary effect obtained when the temporal assistant module 10 is added varies in individual categories. The effect of the temporal assistant module 10 on the original model is verified using the data, and the effect on an object shape being shielded, a part of the object shape moving out of an image, small object detection, and the like that are improved by the temporal assistant module 10 is verified using visualization results.

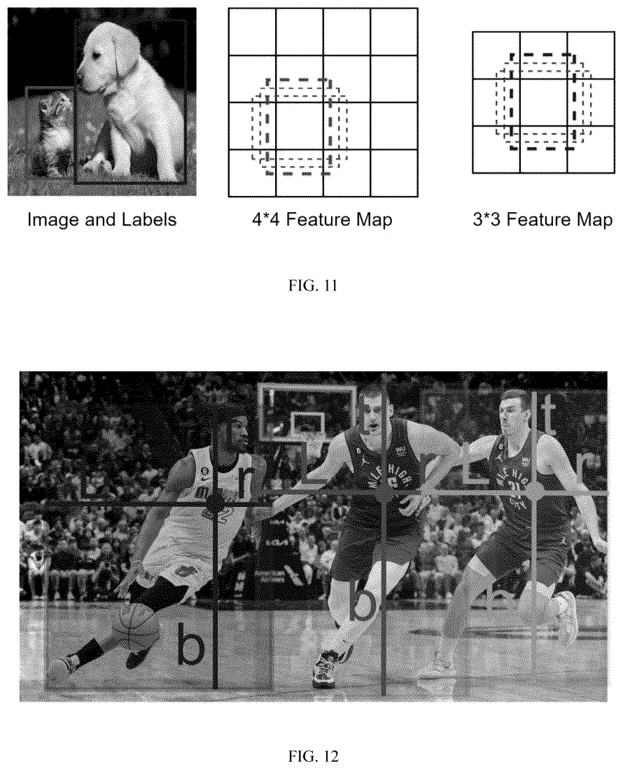

As shown in FIG. 12, the present invention is a temporal assistant module 10. The Anchor Free method is usually defined as all methods in which anchors are not used. Because no anchor is used in the Anchor Free method, no anchor is to be set in advance. Object detection is performed by finding coordinates of a center point of an object on a feature map and predicting distances between the center point and upper, left, and, right boundaries. In the Anchor Free method, no anchor is to be set in advance, and computational costs are not increased because a large number of anchors are to be screened. However, because there is no anchor information, it is difficult for a model to converge on regression of distance information between the center point and boundaries.

As shown in Table 4, the present invention is a temporal assistant module 10 that processes a video frame of a spatio-temporal feature map for object detection, and includes at least one anchor free module, where the anchor free module performs object detection by finding coordinates of a center point of an object on a feature map and predicting distances between the center point and upper, left, and, right boundaries.

As shown in Table 4, the present invention is a temporal assistant module 10. The temporal assistant module is used in the Monodle.

| | 2D AP70↑ | | | BEV AP70↑ | | | 3D AP70↑ | | | BEV AP50↑ | | | 3D P50↑ | | |
|---|---|---|---|---|---|---|---|---|---|---|---|---|---|---|---|
| Car | E | M | H | E | M | H | E | M | H | E | M | H | E | M | H |
| Baseline | 95.54 | 87.09 | 78.87 | 23.74 | 23.03 | 21.43 | 17.26 | 19.16 | 16.71 | 58.70 | 48.78 | 43.36 | 53.25 | 42.59 | 40.60 |
| LSTM | 95.92 | 87.37 | 79.10 | 28.19 | 23.49 | 21.82 | 21.20 | 19.77 | 16.99 | 60.99 | 49.71 | 43.92 | 56.71 | 43.65 | 41.47 |
| Diff. | +0.38 | +0.28 | +0.23 | +4.45 | +0.46 | +0.39 | +3.94 | +0.61 | +0.28 | +2.29 | +0.93 | +0.56 | +3.46 | +1.06 | +0.87 |
| | 2D AP50↑ | | | BEV AP50↑ | | | 3D AP50↑ | | | BEV AP25↑ | | | 3D P25↑ | | |
| Car | E | M | H | E | M | H | E | M | H | E | M | H | E | M | H |
| Baseline | 74.38 | 59.74 | 51.27 | 8.94 | 7.70 | 6.99 | 6.90 | 7.13 | 5.44 | 28.26 | 24.44 | 19.39 | 27.09 | 23.22 | 18.62 |
| LSTM | 66.21 | 64.13 | 56.02 | 8.32 | 6.52 | 6.34 | 8.31 | 6.49 | 5.62 | 29.17 | 25.19 | 23.53 | 28.84 | 24.76 | 20.55 |
| Diff. | −8.17 | +4.39 | +4.75 | −0.62 | −1.18 | −0.65 | −0.2 | −1.1 | +0.18 | +0.91 | +0.75 | +4.14 | +1.75 | +1.54 | +1.93 |
| | 2D AP50↑ | | | BEV AP50↑ | | | 3D AP50↑ | | | BEV AP25↑ | | | 3D P25↑ | | |
| Cyclist | E | M | H | E | M | H | E | M | H | E | M | H | E | M | H |
| Baseline | 67.55 | 45.55 | 45.09 | 8.79 | 5.48 | 5.49 | 7.20 | 5.40 | 5.40 | 23.67 | 15.25 | 14.01 | 23.43 | 15.05 | 13.80 |
| LSTM | 70.25 | 46.32 | 45.85 | 7.96 | 5.65 | 5.65 | 6.51 | 5.50 | 5.51 | 23.15 | 14.17 | 13.43 | 23.15 | 14.17 | 13.43 |
| Diff. | +2.7 | +0.77 | +0.76 | −0.83 | +0.17 | +0.16 | −0.69 | +0.1 | +0.11 | −0.52 | −1.08 | −0.58 | −0.28 | −0.88 | −0.37 |
| | 2D↑ | | | BEV Hard↑ | | | 3D Hard↑ | | | BEV Easy↑ | | | 3D Easy↑ | | |
| mAP | E | M | H | E | M | H | E | M | H | E | M | H | E | M | H |
| Baseline | 79.16 | 64.13 | 58.41 | 13.82 | 12.07 | 11.30 | 10.45 | 10.56 | 9.18 | 36.88 | 29.49 | 25.59 | 34.59 | 26.95 | 24.34 |
| LSTM | 77.46 | 65.94 | 60.32 | 14.82 | 11.89 | 11.27 | 11.47 | 10.43 | 9.37 | 37.77 | 29.69 | 26.96 | 36.23 | 27.53 | 25.15 |
| Diff. | −1.7 | +1.81 | +1.91 | +1 | −0.18 | −0.03 | +1.24 | +0.93 | +0.75 | +0.89 | +0.2 | +1.37 | +1.64 | +0.58 | +0.81 |

As shown in Table 4, the present invention is a temporal assistant module 10. Through experimental data analysis, predicted precision is improved by 0.62 on average by adding the temporal assistant module under the Anchor Free model architecture, and predicted precision of a car among individual objects is increased most stably and obviously. In addition to data comparison, data is also visualized based on object being shielded, object moving out of an image, small object detection, and the like, demonstrating that the detection effect of the Anchor Free model on the above situations can be improved by adding the temporal assistant module provided in the present invention.

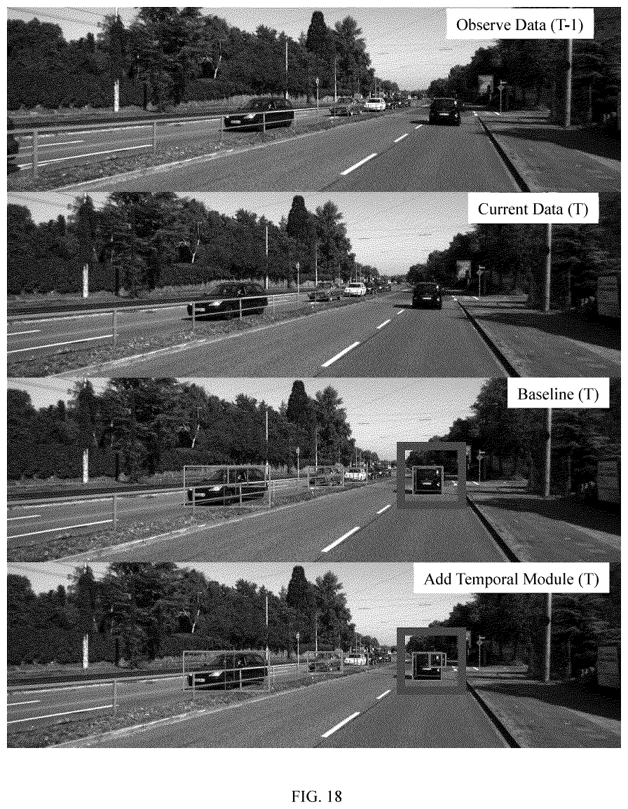

As shown in FIG. 18, the present invention is a temporal assistant module 10. FIG. 18 shows a case in which an object is shielded. It can be seen that a shielded vehicle is not included in prediction of a Baseline model with temporal assist. However, in a model with the temporal assistant module added, the shielded car can be detected with additional reference to special detection information in observed data.

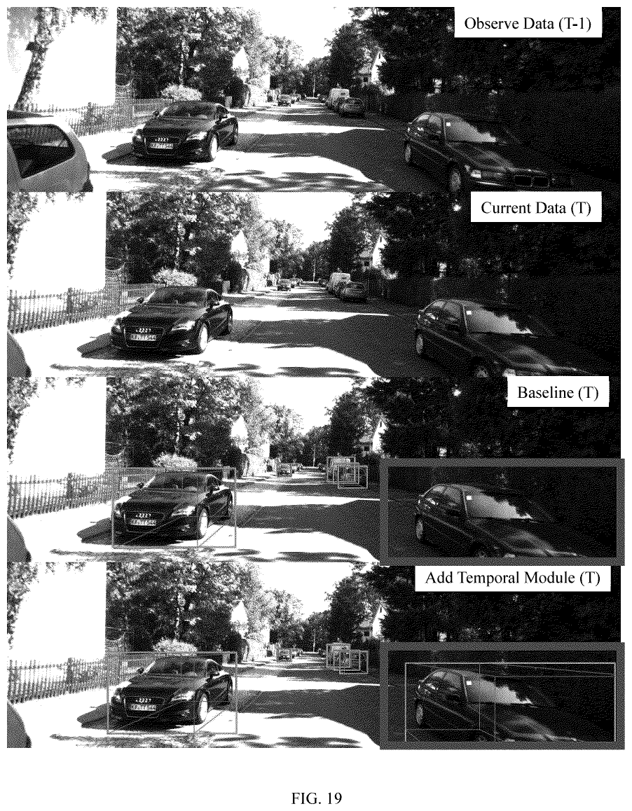

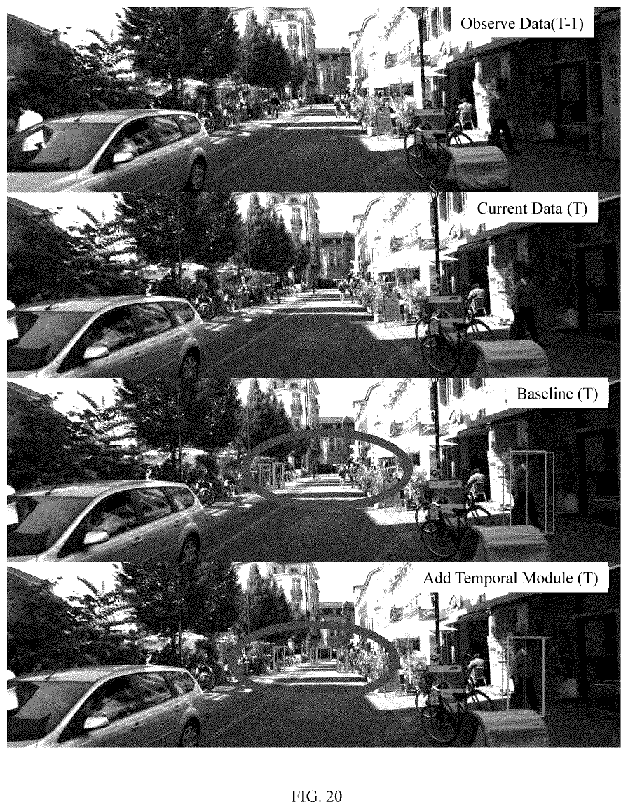

As shown in FIG. 19, the present invention is a temporal assistant module 10. In an example in which an object moves out of an image, as shown in FIG. 19, a Baseline model without temporal assist detects an object only through an image feature in current data. When the object moves out of the image, the object cannot be accurately detected due to the lack of complete special detection information. However, in a model with the temporal assistant module added, with reference to information about the object that does not move out of the image, the object can still be detected when moving out of the image.

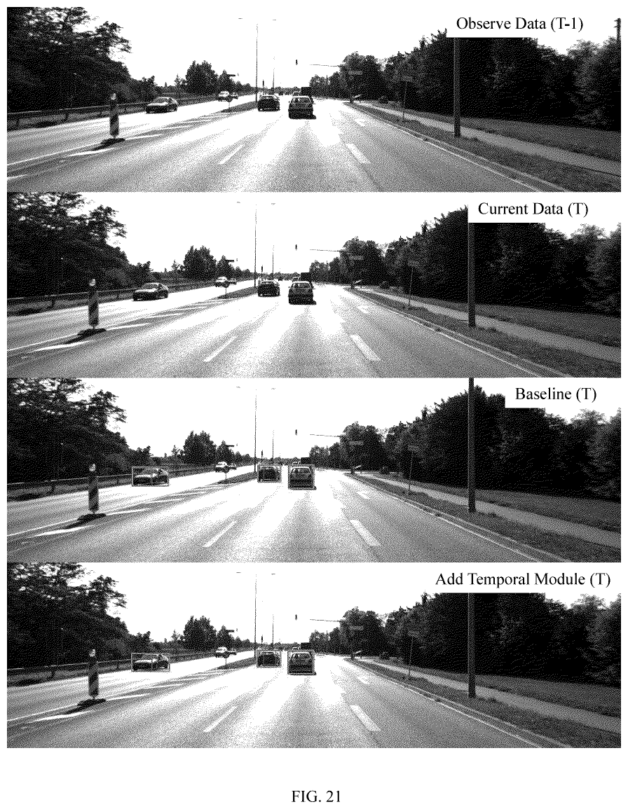

As shown in FIG. 20, the present invention is a temporal assistant module 10. In terms of small object detection, as shown in FIG. 20, in this case, no object moves out of an image or is shielded, but object volume is small because there is a distance from an image capture device. In the temporal assistant module, the detection effect on a small object is improved because observed data reinforces a feature of the current small object.

As shown in FIG. 21, the present invention is a temporal assistant module 10. If no shielding, moving out of an image, or small object detection does not occur, as shown in FIG. 21, although the above special cases do not occur in a scene, and objects in an image appear steadily, the detection effect is not affected before and after the addition of the temporal assistant module.

As shown in Table 5, the present invention is a temporal assistant module 10. Comparison of monocular 3D object detection models is shown as follows:

| | Extra Data | | Car | | | Pedestrian | | | Cyclist | | |
|---|---|---|---|---|---|---|---|---|---|---|---|
| 3D AP70↑ | Depth | Temporal | E | M | H | E | M | H | E | M | H |
| CaDDN | V | Result | 24.87 | 15.63 | 14.47 | 16.51 | 13.37 | 12.21 | 9.68 | 9.09 | 9.09 |
| Kinematic3D | | | 13.01 | 9.43 | 7.38 | 1.19 | 0.57 | 0.57 | 0.00 | 0.00 | 0.00 |
| VisualDet3D | | | 19.43 | 13.60 | 10.82 | 6.94 | 5.11 | 4.31 | 2.44 | 1.41 | 1.43 |
| Monodle | | | 17.26 | 19.16 | 16.71 | 6.90 | 7.13 | 5.44 | 7.20 | 5.40 | 5.40 |
| VisualDet3D | | LSTM | 21.24 | 15.78 | 12.07 | 7.94 | 6.08 | 4.92 | 4.55 | 2.15 | 2.27 |
| Monodle | | LSTM | 21.20 | 19.77 | 16.99 | 6.70 | 6.03 | 5.62 | 6.51 | 5.50 | 5.51 |

As shown in Table 5, the present invention is a temporal assistant module 10. After it is verified that the present invention can be used in different model architectures, in this paragraph, a result obtained when the assistant module provided in the present invention is added is compared with a result obtained when a currently state-of-the-art 3D object detection model is added. In terms of compared objects, a monocular 3D object detection method is selected, and a model that only uses depth information during training or does not use depth information at all is selected as far as possible. CaDDN is used as a compared object in the model that uses depth, and Kinematic3D, Monodle, VisualDet3D are selected as representatives in the model that does not use depth information, and temporal modules are added to two models that do not use depth information for comparison. Experimental results are shown in Table 5, which are divided into two parts. An upper part is the effect obtained with an original model architecture, and a lower part is the effect obtained when the temporal assistant module provided in the present invention is added.

The above description and description are only descriptions of preferred embodiments of the present invention. Those who are skilled in the art may make other modifications in accordance with the scope of the patent application and the above description as defined below, but such modifications shall still be within the scope of claims in the present invention for the spirit of the present invention.

### REFERENCE NUMERALS

Y_{T0} Output state information at a time point T0
X_{T0} Input state information at a time point T0
H_{T0} Hidden state information at a time point T0
Y_{T1} Output state information at a time point T1
X_{T1} Input state information at a time point T1
H_{T1} Hidden state information at a time point T1
Y_{T2} Output state information at a time point T2
X_{T2} Input state information at a time point T2
H_{T2} Hidden state information at a time point T2
Xₜ Input state information at a current time point
Yₜ Output state information at the current time point
Hₜ₋₁ Hidden state information at a previous time point
Hₜ Hidden state information at the current time point
Cₜ₋₁ Cell state at the previous time point
Cₜ Cell state at the current time point
21 Recurrent neural networks module in the prior art
31 Long short-term memory module in the prior art
41 Gated recurrent unit module in the prior art
501 Recurrent neural networks module (RNN module)
601 Long short-term memory module (LSTM module)
701 Gated recurrent unit module (GRU module)
11 Hidden layer
51 First activation function layer
64 Second activation function layer
65 Third activation function layer
73 Fourth activation function layer
54 First convolutional 2D layer
53 Second convolutional 2D layer
56 Third convolutional 2D layer
58 Fourth convolutional 2D layer
55 First connection layer
57 Second connection layer
61 Forget gate
62 Input gate
63 Output gate
71 Reset gate
72 Update gate
81 Backbone layer
82 Neck layer
10 Temporal assistant module
83 Detection head layer

What is claimed is:

1. A temporal assistant module for monocular 3D object detection, wherein the temporal assistant module is connected to at least one of a recurrent neural networks module (RNN module), a long short-term memory module (LSTM module), and a gated recurrent unit module (GRU module) separately, a video frame of a spatio-temporal feature map is processed by the temporal assistant module, and the temporal assistant module comprises:
a first convolutional 2D layer, wherein hidden state information (Hₜ₋₁) at a previous time point is input to the first convolutional 2D layer;
a second convolutional 2D layer, wherein input state information (Xₜ) at a current time point is input to the second convolutional 2D layer;
a first connection layer, wherein the hidden state information (Hₜ₋₁) at the previous time point is output from the first convolutional 2D layer to the first connection layer, and the input state information (Xₜ) is output from the second convolutional 2D layer to the first connection layer; and
a third convolutional 2D layer, wherein the hidden state information (Hₜ₋₁) at the previous time point and the input state information (Xₜ) are output from the first connection layer to the third convolutional 2D layer,
wherein hidden state information (Hₜ) at a current time point and output state information (Yₜ) at the current time point of the recurrent neural networks module, the long short-term memory module (LSTM module), and the gated recurrent unit module (GRU module) are adjusted separately by using the temporal assistant module, thereby enhancing average precision (AP) of auxiliary effect on object being shielded, object moving out of a detection image, or small object detection.

2. The temporal assistant module according to claim 1, wherein the following layers are comprised:
a backbone layer, wherein an input end of the backbone layer is connected to an input data feature, to extract the input data feature; and
an input end of the temporal assistant module is connected to an output end of the backbone layer;
a neck layer, wherein an input end of the neck layer is connected to an output end of the temporal assistant module, to fuse the data feature; and
a detection head layer, wherein an output end of the neck layer is connected to an input end of the detection head layer.

3. The temporal assistant module according to claim 1, wherein the following layers are comprised:
a backbone layer, wherein an input end of the backbone layer is connected to an input data feature, to extract the input data feature;
a neck layer, wherein an input end of the neck layer is connected to an output end of the backbone layer, to fuse the data feature; and
the temporal assistant module is placed in the neck layer to integrate data features at different scales; and
a detection head layer, wherein an output end of the neck layer is connected to an input end of the detection head layer.

4. The temporal assistant module according to claim 1, wherein the following layers are comprised:
a backbone layer, wherein an input end of the backbone layer is connected to an input data feature, to extract the input data feature;
a neck layer, wherein an input end of the neck layer is connected to the backbone layer, to fuse the data feature; and
an input end of the temporal assistant module is connected to an output end of the backbone layer; and
a detection head layer, wherein an output end of the temporal assistant module is connected to an input end of the detection head layer.

5. The temporal assistant module according to claim 1, wherein in the recurrent neural networks module, the hidden state information (Hₜ₋₁) at the previous time point and the input state information (Xₜ) are separately output from the third convolutional 2D layer to a first activation function layer, and the first activation function layer outputs the hidden state information (Hₜ) at the current time point and the output state information (Yₜ) at the current time point separately.

6. The temporal assistant module according to claim 1, wherein the long short-term memory module (LSTM module) comprises:
the third convolutional 2D layer outputs information and is connected to a forget gate, an input gate, a second activation function layer, and an output gate separately, wherein the forget gate, the input gate, and the output gate are Sigmoid functions;
output information of the forget gate is multiplied by Ct=1 information to obtain first information, output information of the input gate is multiplied by output information of the second activation function layer to obtain second information, and after the first information is added to the second information, added information is output to a third activation function layer and a cell state (Cₜ) at a current time point; and
after output information of the second activation function layer is multiplied by information of the output gate, the hidden state information (Hₜ) at the current time point and the output state information (Yₜ) at the current time point are output respectively.

7. The temporal assistant module according to claim 1, wherein the gated recurrent unit module (GRU module) comprises:
the third convolutional 2D layer outputs information and is connected to a reset gate and an update gate separately, wherein the reset gate and the update gate are Sigmoid functions;
after output information of the reset gate is multiplied by output information of the first convolutional 2D layer, multiplied information is output to a second connection layer, output information of the second connection layer is output to a fourth convolutional 2D layer, and output information of the fourth convolutional 2D layer is output to a fourth activation function layer; and
after output information of the first convolutional 2D layer is multiplied by delayed output information of the update gate, third information is output, after output information of the update gate is multiplied by output information of the fourth activation function layer, fourth information is output, and after the third information is added to the fourth information, the hidden state information (Hₜ) at the current time point and the output state information (Yₜ) at the current time point are respectively output.

8. The temporal assistant module according to claim 1, wherein the module processes the video frame of the spatio-temporal feature map for object detection and comprises:
at least one anchor base module, wherein the at least one anchor base module cuts a feature map into a plurality of grids of different proportions, places at least one set anchor base in each grid, captures anchor bases with a highest overlap rate, and performs object detection by adjusting an offset.

9. The temporal assistant module according to claim 1, wherein the module processes the video frame of the spatio-temporal feature map for object detection and comprises:
at least one anchor free module, wherein the anchor free module performs object detection by finding coordinates of a center point of an object on a feature map and predicting distances between the center point and upper, left, and, right boundaries.
